(19) United States
(12) Patent Application Publication
(10) Pub. No.: US 2021/0171060 A1
(43) Pub. Date: Jun. 10, 2021

(54) AUTONOMOUS DRIVING VEHICLE INFORMATION PRESENTATION APPARATUS

(71) Applicant: HONDA MOTOR CO., LTD., Tokyo (JP)

(72) Inventors: Yoshitaka MIMURA, Wako-shi (JP); Yuji TSUCHIYA, Wako-shi (JP); Takashi OSHIMA, Wako-shi (JP); Yuki KIZUMI, Wako-shi (JP)

(21) Appl. No.: 17/117,229

(22) Filed: Dec. 10, 2020

(30) Foreign Application Priority Data
Dec. 10, 2019 (JP) 2019-223300

(51) Int. Cl. B60W 60/00; B60W 30/14; B60W 10/20; B60Q 1/50; G01C 21/34; B60W 30/18; G01C 21/36

(52) U.S. Cl. CPC B60W 60/001; B60W 30/143; B60W 10/20; B60Q 1/503; B60W 2420/52; B60W 30/18163; G01C 21/3691; B60W 2420/42; G01C 21/3492

(57) ABSTRACT

In an autonomous driving vehicle information presentation apparatus, an estimation unit estimates a scheduled path for a host vehicle M. A prediction unit predicts a scheduled path for traffic participants. Based on the scheduled path for the host vehicle and the scheduled path for the traffic participants, an interference determination unit determines whether these two scheduled paths will interfere with each other in a predetermined time period. If the two scheduled paths will interfere with each other in the predetermined time period, an extraction unit extracts a specific traffic participant to be involved in the interference among the traffic participants. An information presentation unit presents information for avoiding the interference to the specific traffic participant extracted by the extraction unit as a presentation target.

### CROSS-REFERENCE TO RELATED APPLICATION

This application is based upon and claims priority from the Japanese Patent Application No. 2019-223300, filed on Dec. 10, 2019, the entire contents of which are incorporated herein by reference.

### BACKGROUND OF THE INVENTION

1. Field of the Invention

The present invention relates to an autonomous driving vehicle information presentation apparatus that presents suitable information from an autonomous driving vehicle to a traffic participant present around the vehicle.

2. Description of the Related Art

Recently, autonomous driving techniques have been vigorously proposed to achieve safe and comfortable driving of a vehicle while reducing the burden on the driver.

The applicant of the present application has disclosed an invention of a vehicle control system as an example of the autonomous driving technique that includes: a detection unit that detects the state of surroundings of a vehicle; an autonomous driving control unit that executes autonomous driving which autonomously controls as least one of the speed and steering of the vehicle based on the state of the surroundings of the vehicle detected by the detection unit; a recognition unit that recognizes the direction of a person from the vehicle based on the state of the surroundings of the vehicle detected by the detection unit; and an output unit that outputs information being recognizable by the person recognized by the recognition unit and having directivity in the direction of the person recognized by the recognition unit (see Japanese Patent Application Publication No. 2017-199317).

In the invention of the vehicle control system according to Japanese Patent Application Publication No. 2017-199317, information which is recognizable by a person recognized by the recognition unit and has directivity in the direction of the recognized person is outputted when a person is present around the host vehicle. This can reduce a sense of unease that the host vehicle may give to the person present around it.

Japanese Patent Application Publication No. Hei 3-235200 discloses an invention of a traffic signal display apparatus that displays the traffic signal display state of a traffic light present ahead of the host vehicle to a vehicle traveling behind the host vehicle.

In the invention of the traffic signal display apparatus according to Japanese Patent Application Publication No. Hei 3-235200, the traffic signal display state of a traffic light present ahead of the host vehicle is displayed to the vehicle traveling behind. This can reliably notify the occupant in the vehicle traveling behind (hereinafter also referred to as “trailing vehicle”) of the traffic signal display state of the traffic light and reduce a sense of unease that may be felt by the occupant in the vehicle traveling behind.

### SUMMARY OF THE INVENTION

Meanwhile, in a case where a congested traffic line is formed at an intersection with no traffic light installed due to traffic congestion, traffic participants that happen to be at this intersection travel paths leading to the respective destinations while giving way to each other.

With the inventions according to Japanese Patent Application Publications Nos. 2017-199317 and Hei 3-235200, however, if an autonomous driving vehicle encounters a situation in which a congested traffic line has been formed at an intersection with no traffic light installed due to traffic congestion as above, the autonomous driving vehicle cannot appropriately communicate with traffic participants that happen to be at this intersection. This makes it extremely difficult to create a smooth traffic environment.

The present invention has been made in view of the above circumstances and makes it an object thereof to provide an autonomous driving vehicle information presentation apparatus that enables an autonomous driving vehicle to create a smooth traffic environment even when encountering a situation in which, for example, a congested traffic line has been formed at an intersection with no traffic light installed due to traffic congestion.

In order to solve the above-described problem, an autonomous driving vehicle information presentation apparatus according to a present invention (1) is an autonomous driving vehicle information presentation apparatus that is used in an autonomous driving vehicle which obtains outside information on an outside including traffic participants present around a host vehicle, generates an action plan for the host vehicle based on the obtained outside information, and autonomously controls at least one of speed and steering of the host vehicle in accordance with the generated action plan, and that presents information to the traffic participants. The autonomous driving vehicle information presentation apparatus comprises: an estimation unit that estimates a scheduled path for the host vehicle based on the action plan; a prediction unit that predicts a scheduled path for the traffic participants based on the outside information; an interference determination unit that determines, based on the scheduled path for the host vehicle estimated by the estimation unit and the scheduled path for the traffic participants predicted by the prediction unit, whether these two scheduled paths will interfere with each other in a predetermined time period; an extraction unit that, when a result of the determination by the interference determination unit indicates that the two scheduled paths will interfere with each other in the predetermined time period, extracts a specific traffic participant to be involved in the interference among the traffic participants; and an information presentation unit that presents information addressed to the traffic participants by using an exterior display apparatus provided at a front portion of the host vehicle, in which the information presentation unit presents information for avoiding the interference to the specific traffic participant extracted by the extraction unit as a presentation target.

According to the present invention, an autonomous driving vehicle can create a smooth traffic environment even when encountering a situation in which, for example, a congested traffic line has been formed at an intersection with no traffic light installed due to traffic congestion.

### BRIEF DESCRIPTION OF THE DRAWINGS

FIG. 1 is an entire configuration diagram of an autonomous driving vehicle including an information presentation apparatus according to an embodiment of the present invention.

FIG. 2 is a functional block configuration diagram illustrating a vehicle control apparatus including an autonomous driving vehicle information presentation apparatus and its peripheral components according to an embodiment of the present invention.

FIG. 3 is a schematic configuration diagram of a human machine interface (HMI) included in the autonomous driving vehicle information presentation apparatus.

FIG. 4 is a diagram illustrating a front structure of the cabin of the autonomous driving vehicle.

FIG. 5A is an exterior diagram illustrating a front structure of the autonomous driving vehicle.

FIG. 5B is an exterior diagram illustrating a rear structure of the autonomous driving vehicle.

FIG. 5C is a front view illustrating a schematic configuration of a right front light unit included in the autonomous driving vehicle.

FIG. 6 is a block configuration diagram conceptually illustrating functions of the autonomous driving vehicle information presentation apparatus.

FIG. 7 is a flowchart to be used to describe the operation of the autonomous driving vehicle information presentation apparatus.

FIG. 8A is a diagram sequentially illustrating a traveling scene of the autonomous driving vehicle requesting to cut into a congested traffic line.

FIG. 8B is a diagram sequentially illustrating the traveling scene of the autonomous driving vehicle requesting to cut into the congested traffic line.

FIG. 9 is a front view illustrating a schematic configuration of a left front light unit included in the autonomous driving vehicle.

FIG. 10A is a diagram illustrating an information presenting state of a front display unit provided at a front portion of the autonomous driving vehicle.

FIG. 10B is a diagram illustrating an information presenting state of a rear display unit provided at a rear portion of the autonomous driving vehicle.

FIG. 10C is a diagram illustrating a modification of the information presenting state of the autonomous driving vehicle information presentation apparatus.

### DETAILED DESCRIPTION OF THE EMBODIMENTS

Autonomous driving vehicle information presentation apparatuses according to embodiments of the present invention will be hereinafter described in detail with reference to the drawings.

Note that, in the drawings be presented below, members having the same function are denoted by the same reference sign. Moreover, the sizes and shapes of members may be changed or exaggerated and schematically illustrated for convenience of explanation.

When the terms “left” and “right” are used in relation to a host vehicle M in the description of the vehicle control apparatuses according to the embodiments of the present invention, the front side of the host vehicle M in the direction of advance is the reference direction. Specifically, in a case where the host vehicle M is, for example, right-hand drive, the driver's seat side will referred to as the right side, and the passenger's seat side will be referred to as the left side.

### [Configuration of Host Vehicle M]

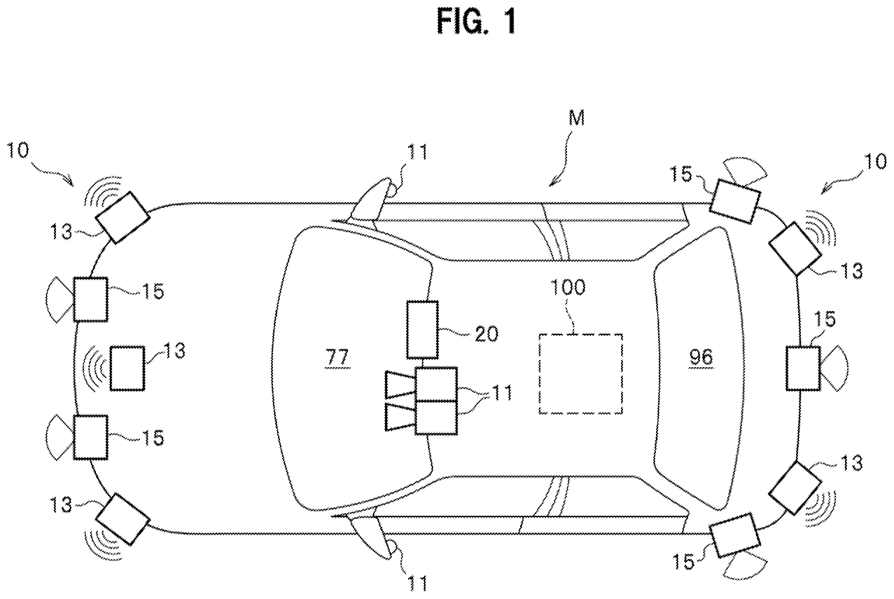

First of all, a configuration of an autonomous driving vehicle (hereinafter also referred to as “host vehicle”) M including a vehicle control apparatus 100 according to an embodiment of present invention will be described with reference to FIG. 1.

FIG. 1 is an entire configuration diagram of the autonomous driving vehicle M including the vehicle control apparatus 100 according to the embodiment of the present invention.

As illustrated in FIG. 1, the host vehicle M equipped with the vehicle control apparatus 100 according to the embodiment of the present invention is an automobile, such as a two-wheeled, three-wheeled, or four-wheeled automobile, for example.

The host vehicle M includes an automobile with an internal combustion engine such as a diesel engine or a gasoline engine as a power source, an electric automobile with an electric motor as a power source, a hybrid automobile with both an internal combustion engine and an electric motor, and the like. Of these, the electric automobile is driven using electric power discharged from a cell such as a secondary cell, a hydrogen fuel cell, a metal fuel cell, or an alcohol fuel cell, for example.

As illustrated in FIG. 1, the host vehicle M is equipped with: an external sensor 10 having a function of detecting outside information on targets including objects and signs present around the host vehicle M; a navigation apparatus 20 having a function of mapping the current position of the host vehicle M onto a map, guiding the host vehicle M to a destination through a route, and so on; and the vehicle control apparatus 100 having a function of controlling self-driving of the host vehicle M including the steering and the acceleration and deceleration of the host vehicle M and so on.

These apparatuses and instruments are configured such that they are connected so as to be capable of communicating data to each other through a communication medium such as a controller area network (CAN), for example.

Note that the “vehicle control apparatus” may include other components (such as the external sensor 10 and an HMI 35) in addition to the components of the “vehicle control apparatus 100” according to this embodiment.

### [External Sensor 10]

The external sensor 10 is configured of cameras 11, radars 13, and lidars 15.

The cameras 11 have an optical axis orientated toward the front side of the host vehicle and tilted obliquely downward, and has a function of capturing an image in the direction of advance of the host vehicle M. In an example, complementary metal oxide semiconductor (CMOS) cameras, charge coupled device (CCD) cameras, or the like can be used as the cameras 11 as appropriate. The cameras 11 are provided near the rearview mirror (not illustrated) inside the cabin of the host vehicle M and on a front portion of a right door and a front portion of a left door outside the cabin of the host vehicle M, or the like.

The cameras 11 repetitively capture images of, for example, a front side in the direction of advance, a right rear side, and a left rear side relative to the host vehicle M on a periodic basis. In this embodiment, the camera 11 provided near the rearview mirror is a pair of monocular cameras arranged side by side. The camera 11 may be a stereo camera.

The pieces of image information on the front side in the direction of advance, the right rear side, and the left rear side relative to the host vehicle M captured by the cameras 11 are transmitted to the vehicle control apparatus 100 through the communication medium.

The radars 13 have a function of obtaining distribution information on targets including a leading vehicle being a following target traveling ahead of the host vehicle M by emitting radar waves to the targets and receiving the radar waves reflected by the targets, the distribution information including the distances to the targets and the orientations of the targets. Laser beams, microwaves, millimeter waves, ultrasonic waves, or the like can be used as the radar waves as appropriate.

In this embodiment, five radars 13 are provided, three on the front side and two on the rear side, as illustrated in FIG. 1. The target distribution information obtained by the radars 13 is transmitted to the vehicle control apparatus 100 through the communication medium.

The lidars 15 (Light Detection and Ranging) have a function of detecting the presence of a target and the distance to a target by, for example, measuring the time taken to detect scattered light of emitted light. In this embodiment, five lidars 15 are provided, two on the front side and three on the rear side, as illustrated in FIG. 1. The target distribution information obtained by the lidars 15 is transmitted to the vehicle control apparatus 100 through the communication medium.

### [Navigation Apparatus 20]

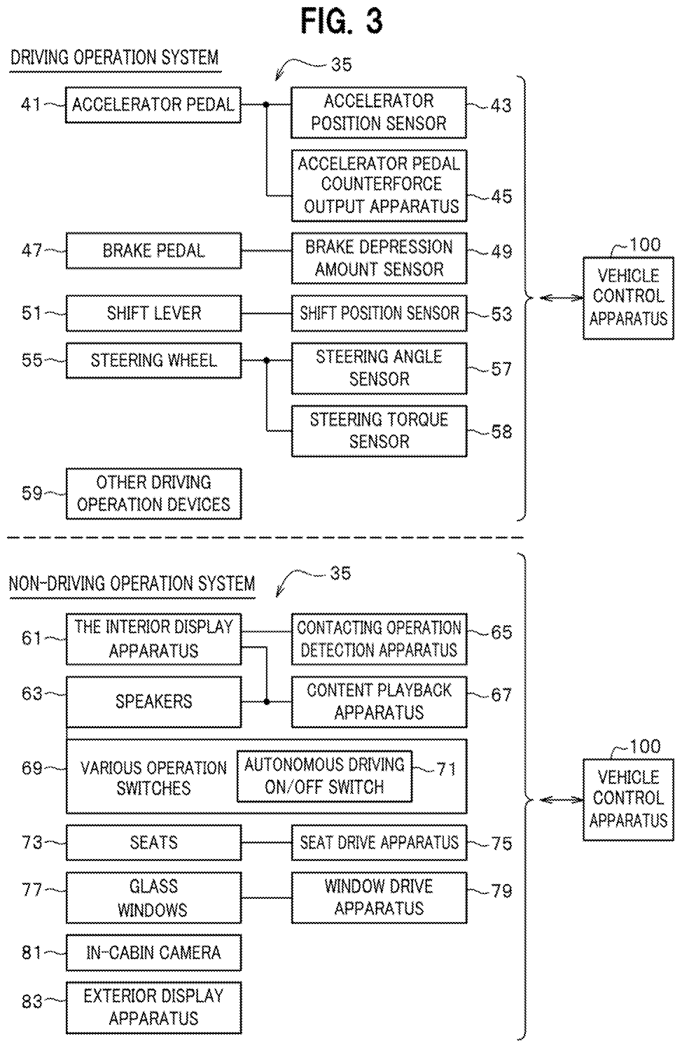

The navigation apparatus 20 is configured of a global navigation satellite system (GNSS) receiver, map information (navigation map), a touchscreen-type interior display apparatus 61 functioning as a human machine interface, speakers 63 (see FIG. 3 for these two), a microphone, and so on. The navigation apparatus 20 serves to locate the current position of the host vehicle M with the GNSS receiver and also to derive a route from the current position to a destination designated by the user.

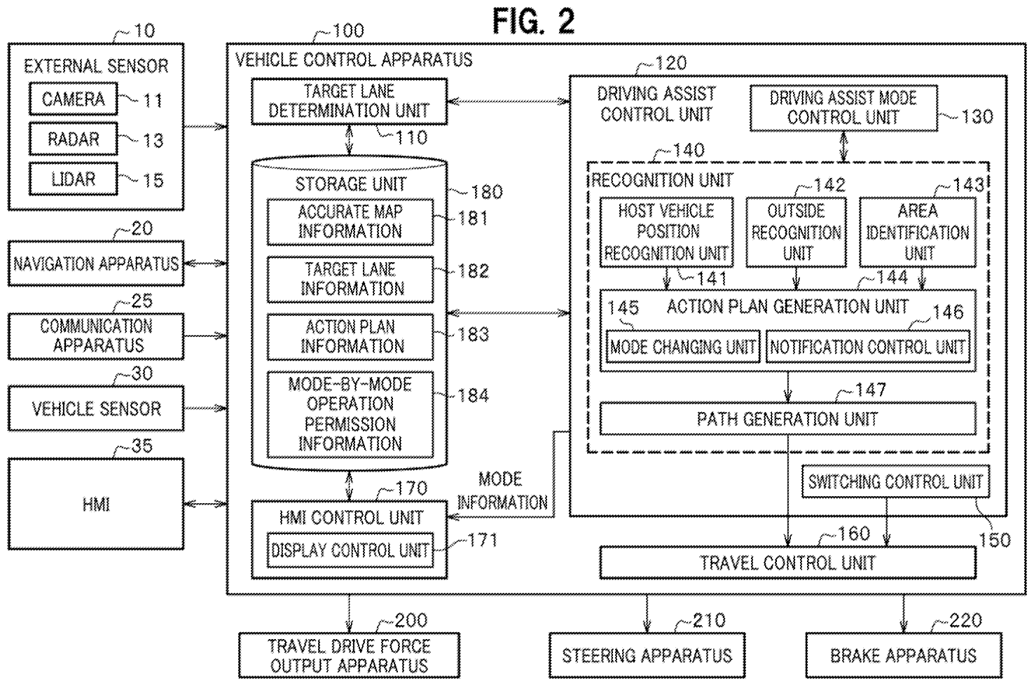

The route derived by the navigation apparatus 20 is provided to a target lane determination unit 110 (described later) of the vehicle control apparatus 100. The current position of the host vehicle M may be identified or complemented by an inertial navigation system (INS) utilizing the outputs of a vehicle sensor 30 (see FIG. 2). Also, while the vehicle control apparatus 100 is executing a manual driving mode, the navigation apparatus 20 navigates through a route to a destination by using sound and voice or by displaying a map.

Note that the function of locating the current position of the host vehicle M maybe provided independently of the navigation apparatus 20. Also, the navigation apparatus 20 maybe implemented by a function of a terminal apparatus such as a smartphone or tablet carried by the user, for example. In this case, information is transmitted and received between the terminal apparatus and the vehicle control apparatus 100 via wireless or wired communication.

### [Vehicle Control Apparatus 100 and Its Peripheral Components]

Next, the vehicle control apparatus 100 and its peripheral components mounted on the host vehicle M according to an embodiment of the present invention will be described with reference to FIG. 2.

FIG. 2 is a functional block configuration diagram illustrating the vehicle control apparatus 100 and its peripheral components according to the embodiment of the present invention.

As illustrated in FIG. 2, the host vehicle M is equipped with a communication apparatus 25, the vehicle sensor 30, the HMI 35, a travel drive force output apparatus 200, a steering apparatus 210, and a brake apparatus 220, as well as the above-described external sensor 10, navigation apparatus 20, and vehicle control apparatus 100.

The communication apparatus 25, the vehicle sensor 30, the HMI 35, the travel drive force output apparatus 200, the steering apparatus 210, and the brake apparatus 220 are configured such that they are connected to the vehicle control apparatus 100 so as to be capable of communicating data to and from the vehicle control apparatus 100 through the communication medium.

### [Communication Apparatus 25]

The communication apparatus 25 has a function of performing communication through a wireless communication medium such as a cellular network, a Wi-Fi network, Bluetooth (registered trademark), or a dedicated short range communication (DSRC), for example.

The communication apparatus 25 wirelessly communicates with, for example, an information providing server of a system that monitors the traffic situations of roads, such as the Vehicle Information and Communication System (VICS) (registered trademark), and obtains traffic information indicating the traffic situation of the road which the host vehicle M is currently traveling or a road which the host vehicle M will be traveling. The traffic information contains pieces of information such as information on congestion ahead, information on the times required to pass through congested areas, information on accidents, failed vehicles, and construction, information on speed restrictions and lane closures, information on the locations of parking lots, and information on the availability of parking lots and rest areas.

The communication apparatus 25 may obtain the traffic information by, for example, communicating with a radio beacon provided on a side margin of the road or the like or performing vehicle-to-vehicle communication with another vehicle traveling around the host vehicle M.

The communication apparatus 25 also wirelessly communicates with, for example, an information providing server of the Traffic Signal Prediction Systems (TSPS) and obtains traffic signal information on traffic lights provided on the road which the host vehicle M is currently traveling or a road which the host vehicle M will be traveling. The TSPS serves to assist driving to smoothly cross intersections with traffic lights by using the traffic signal information on the traffic lights.

The communication apparatus 25 may obtain the traffic signal information by, for example, communicating with an optical beacon provided on a side margin of the road or the like or performing vehicle-to-vehicle communication with another vehicle traveling around the host vehicle M.

### [Vehicle Sensor 30]

The vehicle sensor 30 has a function of detecting various pieces of information on the host vehicle M. The vehicle sensor 30 includes: a vehicle speed sensor that detects the vehicle speed of the host vehicle M; an acceleration sensor that detects the acceleration of the host vehicle M; a yaw rate sensor that detects the angular speed of the host vehicle M about a vertical axis; an orientation sensor that detects the orientation of the host vehicle M; a tilt angle sensor that detects the tilt angle of the host vehicle M; an illuminance sensor that detects the illuminance of the area where the host vehicle M is present; a raindrop sensor that detects the amount of raindrops at the area where the host vehicle M is present; and so on.

### [Configuration of HMI 35]

Next, the HMI 35 will be described with reference to FIGS. 3, 4, 5A, and 5B.

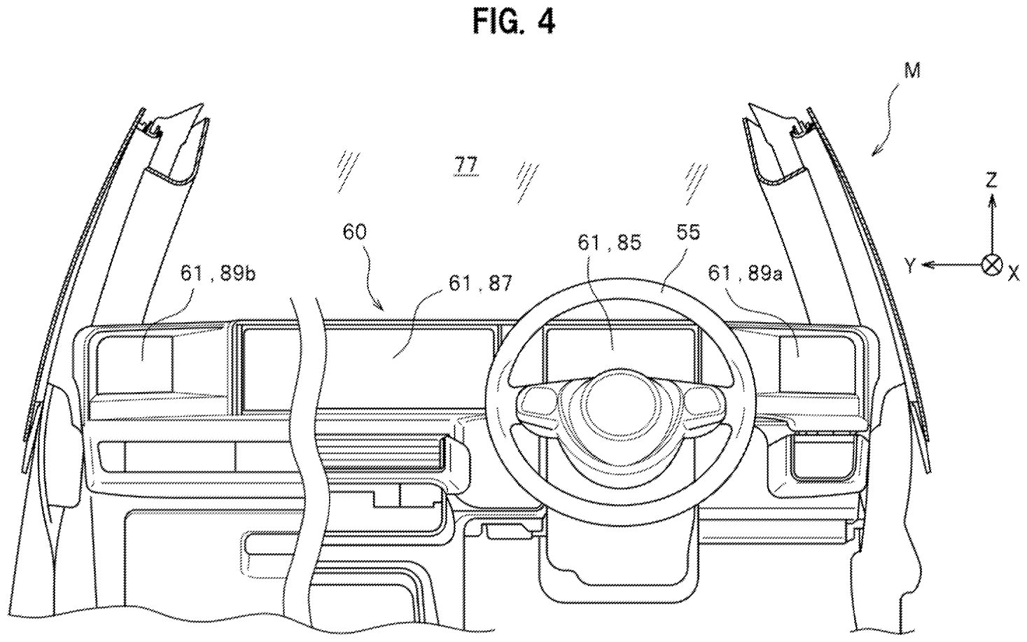

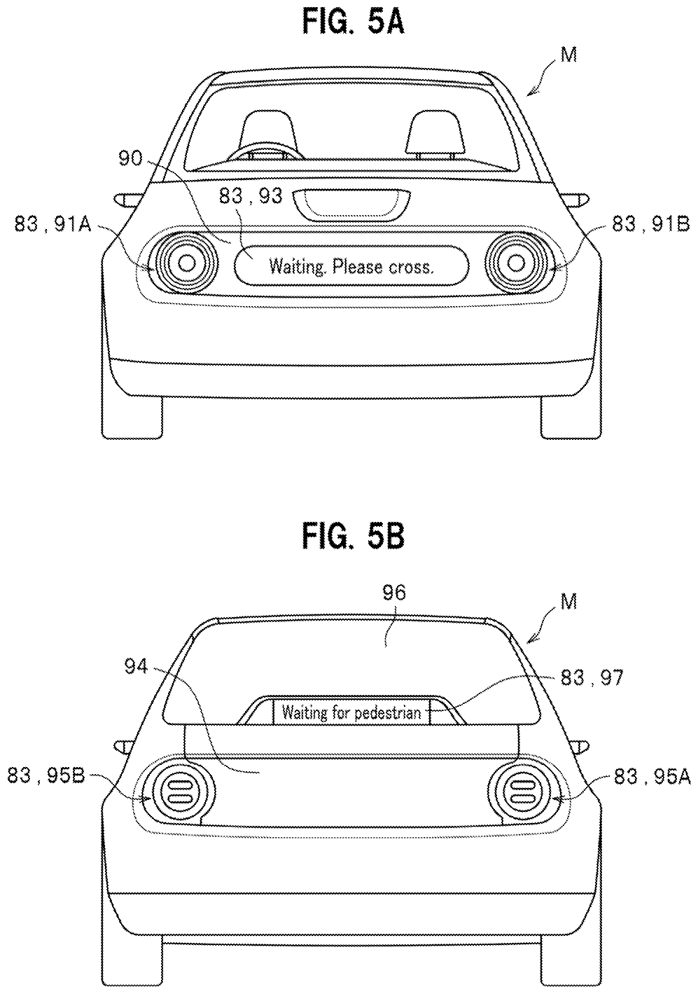

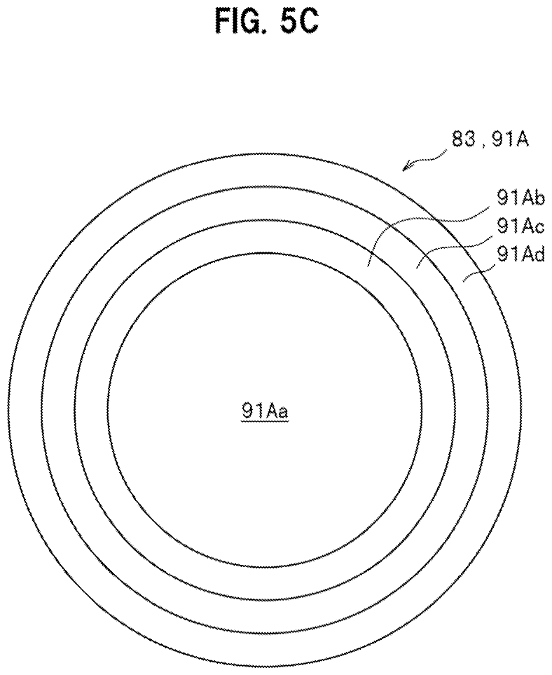

FIG. 3 is a schematic configuration diagram of the HMI 35 connected to the vehicle control apparatus 100 according to an embodiment of the present invention. FIG. 4 is a diagram illustrating a front structure of the cabin of the vehicle M including the vehicle control apparatus 100. FIGS. 5A and 5B are exterior diagrams illustrating a front structure and a rear structure of the vehicle M including the vehicle control apparatus 100, respectively.

As illustrated in FIG. 3, the HMI 35 includes constituent members of a driving operation system and constituent members of a non-driving operation system. There is no clear boundary between them, and a configuration in which constituent members of the driving operation system includes functions of the non-driving operation system (or vice versa) may be employed.

As illustrated in FIG. 3, the HMI 35 includes, as the constituent members of the driving operation system; an accelerator pedal 41, an accelerator position sensor 43, and an accelerator pedal counterforce output apparatus 45; a brake pedal 47 and a brake depression amount sensor 49; a shift lever 51 and a shift position sensor 53; a steering wheel 55, a steering angle sensor 57 and a steering torque sensor 58; and other driving operation devices 59.

The accelerator pedal 41 is an acceleration operator that receives an acceleration instruction (or a deceleration instruction with a returning operation) by the driver. The accelerator position sensor 43 detects the amount of depression of the accelerator pedal 41 and outputs an accelerator position signal indicating the amount of the depression to the vehicle control apparatus 100.

Note that a configuration may be employed which, instead of outputting the accelerator position signal to the vehicle control apparatus 100, outputs the accelerator position signal directly to the travel drive force output apparatus 200, the steering apparatus 210, or the brake apparatus 220. This applies also to the other components of the driving operation system to be described below. The accelerator pedal counterforce output apparatus 45 outputs a force (operation counterforce) to the accelerator pedal 41 in the opposite direction from the direction in which the accelerator pedal 41 is operated, for example, in accordance with an instruction from the vehicle control apparatus 100.

The brake pedal 47 is a deceleration operator that receives a deceleration instruction by the driver. The brake depression amount sensor 49 detects the amount of depression of (or the force of depression on) the brake pedal 47, and outputs a brake signal indicating the result of the detection to the vehicle control apparatus 100.

The shift lever 51 is a gearshift operator that receives a shift stage change instruction by the driver. The shift position sensor 53 detects a shift stage designated by the driver and outputs a shift position signal indicating the result of the detection to the vehicle control apparatus 100.

The steering wheel 55 is a steering operator that receives a turn instruction by the driver. The steering angle sensor 57 detects the operation angle of the steering wheel 55, and outputs a steering angle signal indicating the result of the detection to the vehicle control apparatus 100. The steering torque sensor 58 detects torque applied to the steering wheel 55, and outputs a steering torque signal indicating the result of the detection to the vehicle control apparatus 100.

The steering wheel 55 corresponds to a “driving operator” in the present invention.

The other driving operation devices 59 are, for example, a joystick, buttons, a rotary switch, a graphical user interface (GUI) switch, and so on. The other driving operation devices 59 receive an acceleration instruction, a deceleration instruction, a turn instruction, and so on and output them to the vehicle control apparatus 100.

As illustrated in FIG. 3, the HMI 35 includes, as the constituent members of the non-driving operation system: the interior display apparatus 61; the speakers 63; a contacting operation detection apparatus 65 and a content playback apparatus 67; various operation switches 69; seats 73 and a seat drive apparatus 75; glass windows 77 and a window drive apparatus 79; an in-cabin camera 81; and an exterior display apparatus 83, for example.

The interior display apparatus 61 is a display apparatus preferably of a touchscreen type having a function of displaying various pieces of information to the occupants in the cabin. As illustrated in FIG. 4, the interior display apparatus 61 includes, in an instrument panel 60: a meter panel 85 provided at a position directly opposite the driver's seat; a multi-information panel 87 horizontally elongated in the vehicle width direction (the Y-axis direction in FIG. 4) and provided so as to face the driver's seat and the passenger's seat; a right panel 89a provided on the driver's seat side in the vehicle width direction; and a left panel 89b provided on the passenger's seat side in the vehicle width direction. Note that the interior display apparatus 61 may be provided additionally at such a position as to face the rear seats (the back side of the all seats).

The meter panel 85 displays, for example, a speedometer, a tachometer, an odometer, shift position information, on/off information on lights, and so on.

The multi-information panel 87 displays, for example: map information on the area around the host vehicle M; information on the current position of the host vehicle M on the map; traffic information (including traffic signal information) on the road which the host vehicle M is currently traveling or a route which the host vehicle M will be traveling; traffic participant information on traffic participants (including pedestrians, bicycles, motorcycles, other vehicles, and so on) present around the host vehicle M; various pieces of information such as messages to be presented to the traffic participants; and so on.

The right panel 89a displays image information on a right rear side and a right lower side relative to the host vehicle M captured by the camera 11 provided on the right side of the host vehicle M.

The left panel 89b displays image information on a left rear side and a left lower side relative to the host vehicle M captured by the camera 11 provided on the left side of the host vehicle M.

The interior display apparatus 61 is not particularly limited. For example, it is formed of liquid crystal displays (LCDs), organic electroluminescence (EL) displays, or the like. The interior display apparatus 61 may be formed of head-up displays (HUDs) that project necessary images on the glass windows 77.

The speakers 63 have a function of outputting voice and sound. An appropriate number of speakers 63 are provided at appropriate positions inside the cabin such as in the instrument panel 60, the door panels, and the rear parcel shelf (none of which is illustrated), for example.

When the interior display apparatus 61 is of a touchscreen type, the contacting operation detection apparatus 65 has a function of detecting a touched position on any of the display screens of the interior display apparatus 61 and outputting information on the detected touched position to the vehicle control apparatus 100. The contacting operation detection apparatus 65 can omit this function when the interior display apparatus 61 is not of a touchscreen type.

The content playback apparatus 67 includes, for example, a digital versatile disc (DVD) playback apparatus, a compact disc (CD) playback apparatus, a television receiver, a playback apparatus for various guide images, and so on. Some or all of the interior display apparatus 61, the speakers 63, the contacting operation detection apparatus 65, and the content playback apparatus 67 may be components also used by the navigation apparatus 20.

The various operation switches 69 are arranged at appropriate positions inside the cabin. The various operation switches 69 include an autonomous driving ON/OFF switch 71 that issues an instruction to immediately start autonomous driving (or to start autonomous driving in the future) or to stop autonomous driving. The autonomous driving ON/OFF switch 71 may be a GUI switch or a mechanical switch. The various operation switches 69 may also include switches for driving the seat drive apparatus 75 and the window drive apparatus 79.

The seats 73 are seats for the occupants in the host vehicle M to sit on. The seat drive apparatus 75 freely drives the reclining angles, front-rear positions, yaw angles, and the like of the seats 73. The glass windows 77 are provided to all doors, for example. The window drive apparatus 79 drive the glass windows 77 so as to open or close them.

The in-cabin camera 81 is a digital camera utilizing a solid-state imaging element, such as a CCD or a CMOS. The in-cabin camera 81 is provided at such a position as to be capable of capturing an image of at least the head of the driver sitting on the driver's seat, such as in the rearview mirror, the steering boss (neither of which is illustrated), or the instrument panel 60. In an example, the in-cabin camera 81 repetitively captures an image of the inside of the cabin including the driver on a periodic basis, for example.

The exterior display apparatus 83 has a function of displaying various pieces of information to traffic participants present around the host vehicle M (including pedestrians, bicycles, motorcycles, other vehicles, and so on). As illustrated in FIG. 5A, the exterior display apparatus 83 includes, in a front grill 90 of the host vehicle M, a right front light unit 91A and a left front light unit 91B provided separated from each other in the vehicle width direction, and a front display unit 93 provided between the left and right front light units 91A and 91B.

As illustrated in FIG. 5B, the exterior display apparatus 83 also includes, in a rear grill 94 of the host vehicle M, a right rear light unit 95A and a left rear light unit 95B provided separated from each other in the vehicle width direction, and a rear display unit 97 provided at a position inside the cabin of the host vehicle M at which the rear display unit 97 is visible from outside through a center lower portion of a rear window 96. The rear display unit 97 is provided, for example, at the lower end of an opening for the rear window 96 (not illustrated) or the like.

Here, the configurations of the left and right front light units 91A and 91B of the exterior display apparatus 83 will now be described with reference to FIG. 5C. FIG. 5C is a front view illustrating a schematic configuration of the right front light unit 91A included in the host vehicle M. Note that the left and right front light units 91A and 91B have the same configuration. Thus, the schematic configuration of the right front light unit 91A will be described as a description of the configurations of the left and right front light units 91A and 91B.

The right front light unit 91A is formed in a circular shape in a front view. The right front light unit 91A is configured such that a turn signal 91Ab, a light display part 91Ac, and a position lamp 91Ad each formed in an annular shape are arranged concentrically in this order toward the radially outer side and centered around a headlamp 91Aa formed in a circular shape in a front view having a smaller diameter than the outer diameter of the right front light unit 91A.

The headlamp 91Aa serves to assist the occupant to view ahead while the host vehicle M is traveling through a dark area by illuminating the front side in the direction of advance with light. The turn signal 91Ab serves to notify traffic participants present around the host vehicle M of an intention to turn left or right when the host vehicle M does so. The light display part 91Ac serves to notify traffic participants present around the host vehicle M of traveling intention of the host vehicle M including stopping (this will be described later in detail) along with a content displayed on the front display unit 93. The position lamp 91Ad serves to notify traffic participants present around the host vehicle M of its vehicle width while the host vehicle M is traveling through a dark area.

### [Configuration of Vehicle Control Apparatus 100]

Next, referring back to FIG. 2, a configuration of the vehicle control apparatus 100 will be described.

The vehicle control apparatus 100 is implemented by, for example, at least one processor or hardware having an equivalent function. The vehicle control apparatus 100 may be configured of a combination of electronic control units (ECUs), micro-processing units (MPUs), or the like in each of which a processor such as a central processing unit (CPU), a storage apparatus, and a communication interface are connected by an internal bus.

The vehicle control apparatus 100 includes the target lane determination unit 110, a driving assist control unit 120, a travel control unit 160, an HMI control unit 170, and a storage unit 180.

The functions of the target lane determination unit 110 and the driving assist control unit 120 and part or entirety of the function of the travel control unit 160 are implemented by the processor executing programs (software). Also, some or all of these functions may be implemented by hardware such as a large scale integration (LSI) circuit or an application specific integrated circuit (ASIC) or be implemented by a combination of software and hardware.

In the following description, when a subject is mentioned like “˜unit does . . . ”, the driving assist control unit 120 reads out the corresponding program from a read only memory (ROM) or an electrically erasable programmable read-only memory (EEPROM) as necessary, loads it into a random access memory (RAM), and executes the corresponding function (described later).

The program may be prestored in the storage unit 180, or taken into the vehicle control apparatus 100 from another storage medium or through a communication medium as necessary.

### [Target Lane Determination Unit 110]

The target lane determination unit 110 is implemented by a micro processing unit (MPU), for example. The target lane determination unit 110 divides a route provided from the navigation apparatus 20 into a plurality of blocks (for example, divides the route at 100 [m]—intervals in the direction of advance of the vehicle), and determines a target lane in each block by referring to accurate map information 181. For example, the target lane determination unit 110 determines which lane from the left to travel. When, for example, a branching point, a merging point, or the like is present on the route, the target lane determination unit 110 determines the target lane such that the host vehicle M will be able to travel a rational traveling route for advancing to the target branched path. The target lane determined by the target lane determination unit 110 is stored in the storage unit 180 as target lane information 182.

### [Driving Assist Control Unit 120]

The driving assist control unit 120 includes a driving assist mode control unit 130, a recognition unit 140, and a switching control unit 150.

### <Driving Assist Mode Control Unit 130>

The driving assist mode control unit 130 determines an autonomous driving mode (autonomous driving assisting state) to be executed by the driving assist control unit 120 based on an operation of the HMI 35 by the driver, an event determined by an action plan generation unit 144, how the host vehicle M should travel determined by a path generation unit 147, and so on. The HMI control unit 170 is notified of the autonomous driving mode.

Each autonomous driving mode can be switched (overridden) to a lower-level autonomous driving mode by an operation of a constituent element of the driving operation system in the HMI 35.

The override is initiated, for example, when a constituent element of the driving operation system in the HMI 35 by the driver of the host vehicle M continues to be operated for longer than a predetermined time, when a predetermined amount of change in operation (e.g., the accelerator position of the accelerator pedal 41, the brake depression amount of the brake pedal 47, or the steering angle of the steering wheel 55) is exceeded, when a constituent element of the driving operation system is operated more than a predetermined number of times, or the like.

### <Recognition Unit 140>

The recognition unit 140 includes a host vehicle position recognition unit 141, an outside recognition unit 142, an area identification unit 143, the action plan generation unit 144, and the path generation unit 147.

### <Host Vehicle Position Recognition Unit 141>

The host vehicle position recognition unit 141 recognizes the traveling lane which the host vehicle M is currently traveling and the position of the host vehicle M relative to the traveling lane, based on the accurate map information 181 stored in the storage unit 180 and information inputted from the cameras 11, the radars 13, the lidars 15, the navigation apparatus 20, or the vehicle sensor 30.

The host vehicle position recognition unit 141 recognizes the traveling lane by comparing the pattern of road section lines recognized from the accurate map information 181 (e.g., the arrangement of continuous lines and broken lines) and the pattern of the road section lines around the host vehicle M recognized from images captured by the cameras 11. In this recognition, the current position of the host vehicle M obtained from the navigation apparatus 20 and the result of processing by the INS maybe taken into account.

### <Outside Recognition Unit 142>

As illustrated in FIG. 2, the outside recognition unit 142 recognizes an outside situation including, for example, the positions, vehicle speeds, and accelerations of nearby vehicles based on the information on the outside inputted from the external sensor 10 including the cameras 11, the radars 13, and the lidars 15. The nearby vehicles refer to, for example, other vehicles traveling around the host vehicle M in the same direction as the host vehicle M (a leading vehicle and a trailing vehicle; details will be described later).

The positions of the nearby vehicles may be represented as the centers of gravity of these other vehicles or representative points such as corners, or represented as areas expressed by the contours of the other vehicles. The states of the nearby vehicles may include the speeds and accelerations of the nearby vehicles and whether the nearby vehicles are changing lanes (or whether they are about to change lanes) which are figured out based on information from the above-mentioned various instruments. Alternatively, the outside recognition unit 142 may employ a configuration that recognizes the positions of targets including guard rails, utility poles, parked vehicles, pedestrians, and traffic signs, as well as the nearby vehicles including the leading vehicle and the trailing vehicle.

In embodiments of the present invention, of the nearby vehicles, the vehicle that is traveling immediately ahead of the host vehicle M in the same traveling lane as that of the host vehicle M and is a following target in following travel control will be referred to as “leading vehicle”. Also, of the nearby vehicles, the vehicle that is traveling immediately behind the host vehicle M in the same traveling lane as that of the host vehicle M will be referred to as “trailing vehicle”.

### <Area Identification Unit 143>

The area identification unit 143 obtains information on specific areas present around the host vehicle M (interchanges: ICs, junctions: JCTs, and points where the number of lanes increases or decreases) based on map information. In this way, the area identification unit 143 can obtain information on specific areas that assist the host vehicle M to travel smoothly even if the host vehicle M is hidden behind vehicles ahead including the leading vehicle and cannot capture an image in the direction of advance with the external sensor 10.

Instead of obtaining the information on specific areas based on the map information, the area identification unit 143 may obtain the information on the specific areas by identifying targets with image processing based on an image in the direction of advance captured with the external sensor 10 or by recognizing targets based on the contours in an image in the direction of advance with internal processing by the outside recognition unit 142.

Also, a configuration may be employed which, as will be described later, uses the VICS information obtained by the communication apparatus 25 to enhance the accuracy of the information on the specific areas obtained by the area identification unit 143.

### <Action Plan Generation Unit 144>

The action plan generation unit 144 sets the start point of autonomous driving and/or the destination point of the autonomous driving. The start point of the autonomous driving may be the current position of the host vehicle M or a geographical point at which an operation is performed as an instruction to perform the autonomous driving. The action plan generation unit 144 generates an action plan in the zone from this start point to the destination point of the autonomous driving. Note that the action plan is not limited to the above, and the action plan generation unit 144 may generate action plans for any zones.

The action plan is formed of a plurality of events to be executed in turn, for example. Examples of the plurality of events include: a deceleration event in which the host vehicle M is caused to decelerate; an acceleration event in which the host vehicle M is caused to accelerate; a lane keep event in which the host vehicle M is caused to travel so as not to depart from its traveling lane; a lane change event in which the host vehicle M is caused to change its traveling lane; a passing event in which the host vehicle M is caused to pass the leading vehicle; a branching event in which the host vehicle M is caused to change to the desired lane at a branching point or to travel so as not to depart from the current traveling lane; a merge event in which the host vehicle M is in a merging lane for merging into a main lane and is caused to accelerate or decelerate and change its traveling lane; a handover event in which the host vehicle M is caused to transition from the manual driving mode to an autonomous driving mode (autonomous driving assisting state) at the start point of the autonomous driving or transition from the autonomous driving mode to the manual driving mode at the scheduled end point of the autonomous driving; and so on.

The action plan generation unit 144 sets a lane change event, a branching event, or a merge event at each point where the target lane determined by the target lane determination unit 110 changes. Information indicating the action plan generated by the action plan generation unit 144 is stored in the storage unit 180 as action plan information 183.

The action plan generation unit 144 includes a mode changing unit 195 and a notification control unit 146.

### <Mode Changing Unit 145>

Based, for example, on the result of recognition of the targets present in the direction of advance of the host vehicle M by the outside recognition unit 142, the mode changing unit 145 selects a driving mode suitable for the recognition result from among driving modes including a plurality of preset levels of autonomous driving modes and the manual driving mode, and causes the host vehicle M to perform autonomous driving using the selected driving mode.

### <Notification Control Unit 146>

When the mode changing unit 145 changes the driving mode of the host vehicle M, the notification control unit 146 issues a notice indicating the driving mode of the host vehicle M has been changed. The notification control unit 146, for example, causes the speakers 63 to output audio information prestored in the storage unit 180 to issue a notice indicating that the driving mode of the host vehicle M has been changed.

Note that the notice is not limited to an audio notice. The notice may be issued in the form of a display, emitted light, a vibration, or a combination of these as long as it can notify the driver of the change in the driving mode of the host vehicle M.

### <Path Generation Unit 147>

The path generation unit 147 generates a path which the host vehicle M should travel, based on the action plan generated by the action plan generation unit 144.

### <Switching Control Unit 150>

As illustrated in FIG. 2, the switching control unit 150 switches the driving mode between an autonomous driving mode and the manual driving mode based on a signal inputted from the autonomous driving ON/OFF switch 71 (see FIG. 3) and so on. Also, based on an operation of a constituent element of the driving operation system in the HMI 35 performed as an accelerating, decelerating, or steering instruction, the switching control unit 150 switches the current autonomous driving mode to a lower-level driving mode. For example, if a state where an operation amount indicated by a signal inputted from a constituent element of the driving operation system in the HMI 35 is above a threshold value continues for a reference time or longer, the switching control unit 150 switches (overrides) the current autonomous driving mode to a lower-level driving mode.

Also, the switching control unit 150 may perform switching control that brings the driving mode back to the original autonomous driving mode if detecting no operation on any constituent elements of the driving operation system in the HMI 35 for a predetermined time after the switching to the lower-level driving mode by the override.

### <Travel Control Unit 160>

The travel control unit 160 controls travel of the host vehicle M by controlling the travel drive force output apparatus 200, the steering apparatus 210, and the brake apparatus 220 such that the host vehicle M will pass through the path generated by the path generation unit 147, which the host vehicle M should travel, on the scheduled time.

### <HMI Control Unit 170>

When notified of setting information on the autonomous driving mode of the host vehicle M by the driving assist control unit 120, the HMI control unit 170 refers to mode-by-mode operation permission information 184 and controls the HMI 35 according to contents set for the autonomous driving mode.

As illustrated in FIG. 2, based on the information on the driving mode of the host vehicle M obtained from the driving assist control unit 120 and by referring to the mode-by-mode operation permission information 184, the HMI control unit 170 determines the apparatuses permitted to be used (the navigation apparatus 20 and part or entirety of the HMI 35) and the apparatuses not permitted to be used. Also, based on the result of the above determination, the HMI control unit 170 controls whether to accept the driver's operations of the driving operation system in the HMI 35 and the navigation apparatus 20.

For example, when the driving mode executed by the vehicle control apparatus 100 is the manual driving mode, the HMI control unit 170 accepts the driver's operations of the driving operation system in the HMI 35 (e.g., the accelerator pedal 41, the brake pedal 47, the shift lever 51, the steering wheel 55, and so on; see FIG. 3).

The HMI control unit 170 includes a display control unit 171.

### <Display Control Unit 171>

The display control unit 171 controls displays on the interior display apparatus 61 and the exterior display apparatus 83. Specifically, for example, when the driving mode executed by the vehicle control apparatus 100 is an autonomous driving mode with a high degree of autonomy, the display control unit 171 performs control that causes the interior display apparatus 61 and/or the exterior display apparatus 83 to display information such as a reminder, warning, or driving assistance to traffic participants present around the host vehicle M. This will be described later in detail.

### <Storage Unit 180>

The storage unit 180 stores pieces of information such as the accurate map information 181, the target lane information 182, the action plan information 183, and the mode-by-mode operation permission information 184, for example. The storage unit 180 is implemented with a ROM, a RAM, a hard disk drive (HDD), a flash memory, or the like. The programs to be executed by the processor may be prestored in the storage unit 180 or downloaded from an external apparatus via in-vehicle Internet equipment or the like. Alternatively, the programs maybe installed into the storage unit 180 by connecting a mobile storage medium storing the programs to a drive apparatus not illustrated.

The accurate map information 181 is map information that is more accurate than the normal map information included in the navigation apparatus 20. The accurate map information 181 contains, for example, information on the centers of lanes, information on the boundaries of the lanes, and so on. The boundaries of the lanes include the types, colors, and lengths of lane marks, the widths of roads, the widths of shoulders, the widths of main lanes, the widths of lanes, the positions of boundaries, the types of boundaries (guard rail, plant, and curb), hatched zones, and so on, and these boundaries are contained in an accurate map.

The accurate map information 181 may also contain road information, traffic regulation information, address information (addresses and postal codes), facility information, telephone number information, and so on. The road information contains information indicating the types of roads such as expressways, tollways, national highways, and prefectural roads, and information on the number of lanes in each road, the width of each lane, the gradient of the road, the position of the road (three-dimensional coordinates including the longitude, latitude, and height), the curvature of the lane, the positions of merging or branching points on the lane, the signs provided on the road, and so on. The traffic regulation information contains information such as the occurrence of lane closures due to construction, traffic accident, congestion, or the like.

### [Travel Drive Force Output Apparatus 200, Steering Apparatus 210, and Brake Apparatus 220]

As illustrated in FIG. 2, the vehicle control apparatus 100 controls the drive of the travel drive force output apparatus 200, the steering apparatus 210, and the brake apparatus 220 in accordance with a travel control instruction from the travel control unit 160.

### <Travel Drive Force Output Apparatus 200>

The travel drive force output apparatus 200 outputs drive force (torque) for causing the host vehicle M to travel to its drive wheels. When the host vehicle M is an automobile with an internal combustion engine as a power source, the travel drive force output apparatus 200 includes, for example, the internal combustion engine, a transmission, and an engine electronic control unit (ECU) that controls the internal combustion engine (none of which is illustrated).

Alternatively, when the host vehicle M is an electric automobile with an electric motor as a power source, the travel drive force output apparatus 200 includes a motor for traveling and a motor ECU that controls the motor for traveling (neither of which is illustrated).

Still alternatively, when the host vehicle M is a hybrid automobile, the travel drive force output apparatus 200 includes an internal combustion engine, a transmission, an engine ECU, a motor for traveling, and a motor ECU (none of which is illustrated).

When the travel drive force output apparatus 200 includes only an internal combustion engine, the engine ECU adjusts the throttle opening degree of the internal combustion engine, the shift stage, and so on in accordance with later-described information inputted from the travel control unit 160.

When the travel drive force output apparatus 200 includes only a motor for traveling, the motor ECU adjusts the duty ratio of a PWM signal to be applied to the motor for traveling in accordance with information inputted from the travel control unit 160.

When the travel drive force output apparatus 200 includes an internal combustion engine and a motor for traveling, the engine ECU and the motor ECU cooperate with each other to control the travel drive force in accordance with information inputted from the travel control unit 160.

### <Steering Apparatus 210>

The steering apparatus 210 includes, for example, a steering ECU and an electric motor (neither of which is illustrated). The electric motor changes the direction of the turning wheels by exerting force on a rack-and-pinion mechanism, for example. The steering ECU drives the electric motor in accordance with information inputted from the vehicle control apparatus 100 or steering angle or steering torque information inputted, to thereby change the direction of the turning wheels.

### <Brake Apparatus 220>

The brake apparatus 220 is, for example, an electric servo brake apparatus including a brake caliper, a cylinder that transfers hydraulic pressure to the brake caliper, an electric motor that generates the hydraulic pressure in the cylinder, and a braking control unit (none of which is illustrated). The braking control unit of the electric servo brake apparatus controls the electric motor in accordance with information inputted from the travel control unit 160 to output a brake torque corresponding to a braking operation to each wheel. The electric servo brake apparatus may include a mechanism, as a backup, that transfers hydraulic pressure generated by operating the brake pedal 47 to the cylinder through a master cylinder.

Note that the brake apparatus 220 is not limited to the above-described electric servo brake apparatus, and may be an electronically controlled hydraulic brake apparatus. The electronically controlled hydraulic brake apparatus controls an actuator in accordance with information inputted from the travel control unit 160 to transfer hydraulic pressure in a master cylinder to a cylinder. Also, the brake apparatus 220 may include a regenerative brake using a motor for traveling that can be included in the travel drive force output apparatus 200.

### [Block Configuration of Autonomous Driving Vehicle Information Presentation Apparatus 300]

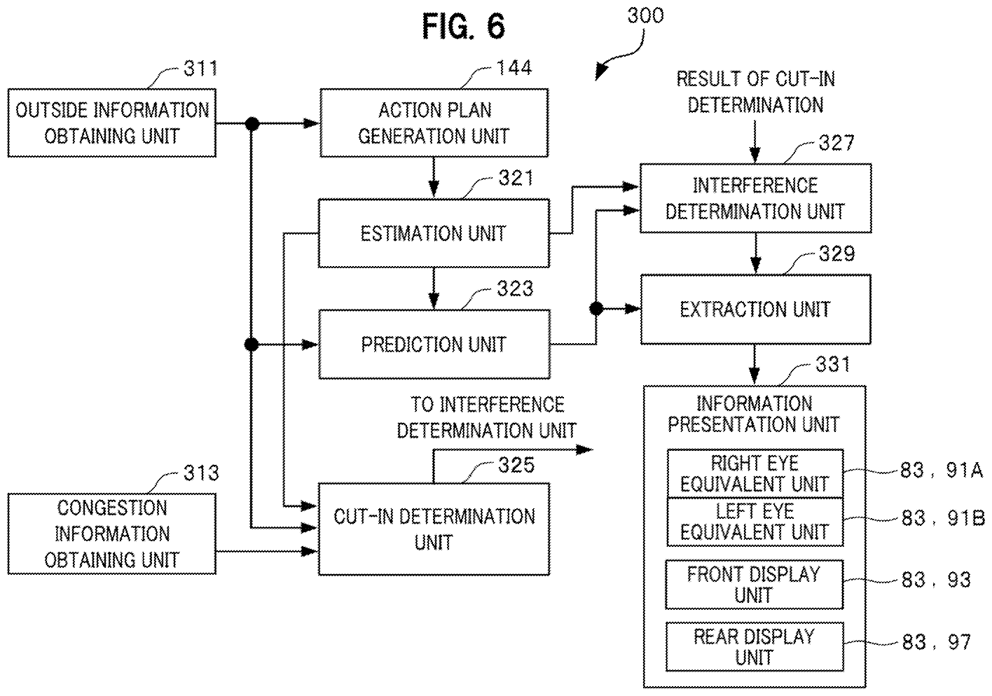

Next, a block configuration of an autonomous driving vehicle information presentation apparatus 300 according to an embodiment of the present invention included in the above-described vehicle control apparatus 100 will be described with reference to FIG. 6.

FIG. 6 is a block configuration diagram conceptually illustrating functions of the autonomous driving vehicle information presentation apparatus 300 according to the embodiment of the present invention.

As illustrated in FIG. 6, the autonomous driving vehicle information presentation apparatus 300 according to the embodiment of the present invention is configured of an outside information obtaining unit 311, a congestion information obtaining unit 313, an action plan generation unit 144 (see FIG. 2), an estimation unit 321, a prediction unit 323, a cut-in determination unit 325, an interference determination unit 327, an extraction unit 329, and an information presentation unit 331.

### <Outside Information Obtaining Unit 311>

As illustrated in FIG. 6, the outside information obtaining unit 311 has a function of obtaining outside information on the state of distribution of targets present in an area around the host vehicle M including areas ahead of the host vehicle M in the direction of advance which are detected by the external sensor 10. The outside information obtaining unit 311 is a functional member corresponding to the recognition unit 140 of the vehicle control apparatus 100 illustrated in FIG. 2.

Note that the channel for the outside information obtaining unit 311 to obtain the outside information is not limited to the external sensor 10. For example, the navigation apparatus 20 and the communication apparatus 25 may be employed.

### <Congestion Information Obtaining Unit 313>

As illustrated in FIG. 6, the congestion information obtaining unit 313 has a function of obtaining congestion information on congestion ahead of the host vehicle M in the direction of advance. The congestion information obtaining unit 313 is a functional member corresponding to the recognition unit 140 of the vehicle control apparatus 100 illustrated in FIG. 2.

Note that the channel for the congestion information obtaining unit 313 to obtain the congestion information is not particularly limited. For example, the congestion information obtaining unit 313 may employ a configuration that obtains the congestion information based on VICS traffic information obtained via the communication apparatus 25 or traffic information obtained via road-to-vehicle communication or vehicle-to-vehicle communication using the communication apparatus 25.

### <Estimation Unit 321>

As illustrated in FIG. 6, the estimation unit 321 has a function of estimating a scheduled path 351 for the host vehicle M based on the action plan for the host vehicle M generated by the action plan generation unit 144 (see FIG. 2). The scheduled path 351 for the host vehicle M estimated by the estimation unit 321 is a path which the host vehicle M will be traveling in a predetermined time period starting from the point when the estimation is made.

The estimation unit 321 is a functional member corresponding to the recognition unit 140 of the vehicle control apparatus 100 illustrated in FIG. 2.

### <Prediction Unit 323>

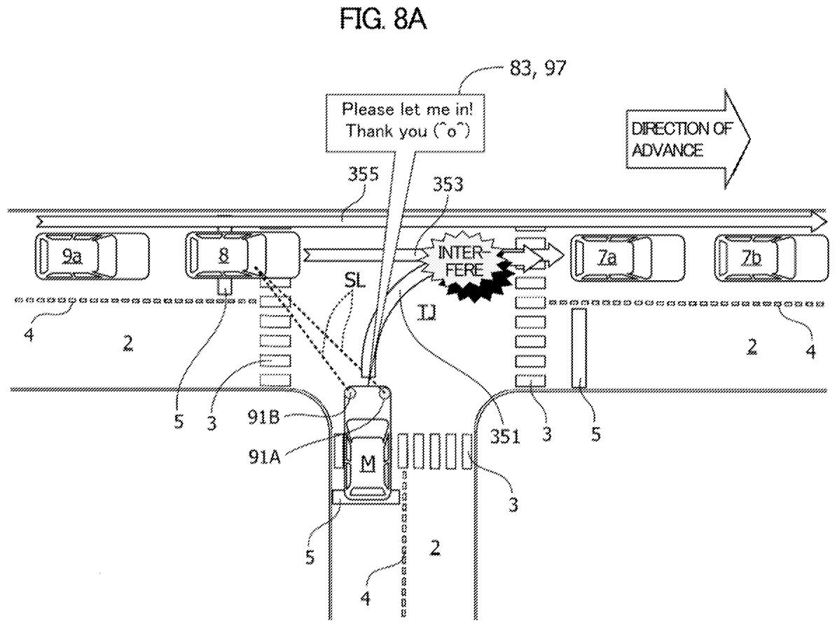

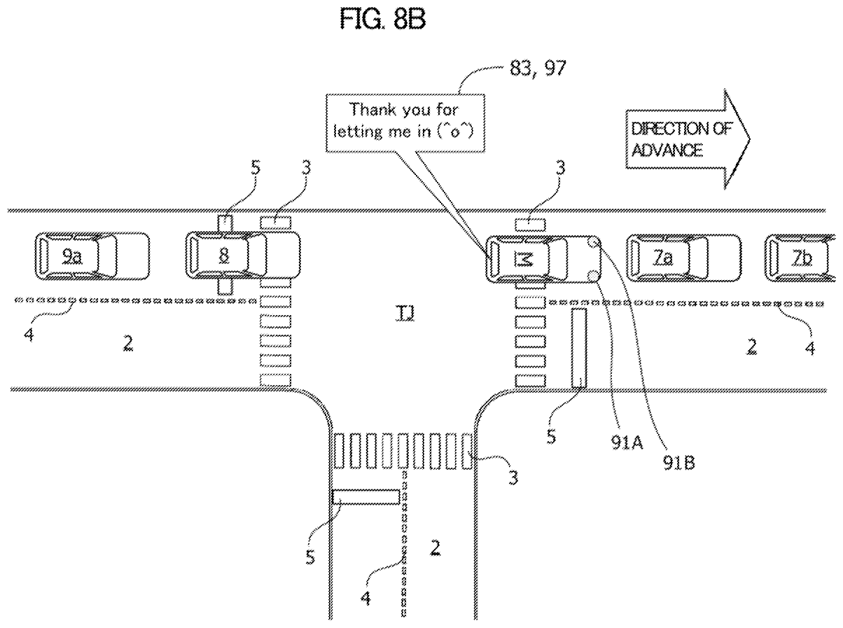

As illustrated in FIG. 6A, the prediction unit 323 has a function of predicting a scheduled path 353 for traffic participants present around the host vehicle M based on the outside information obtained by the outside information obtaining unit 311. With the prediction unit 323, other vehicles present around the host vehicle Mare assumed as traffic participants. The scheduled path 353 for the traffic participants (candidate vehicle 8; see FIG. 8A) predicted by the prediction unit 323 is a path which the traffic participants (candidate vehicle 8) will be traveling in a predetermined time period starting from the point when the prediction is made.

The prediction unit 323 is a functional member corresponding to the recognition unit 140 of the vehicle control apparatus 100 illustrated in FIG. 2.

### <Cut-In Determination Unit 325>

As illustrated in FIG. 6, the cut-in determination unit 325 has a function of determining whether the host vehicle M is in a traffic situation in which the host vehicle M needs to cut into a congested traffic line 355 (see FIG. 8A), based on the congestion information obtained by the congestion information obtaining unit 313, the outside information obtained by the outside information obtaining unit 311, and the scheduled path 351 for the host vehicle M estimated by the estimation unit 321. In the case where the congested traffic line 355 has been formed ahead of the host vehicle M in the direction of advance, the cut-in determination unit 325 determines whether the host vehicle M is in a traffic situation in which the host vehicle M needs to cut into the congested traffic line 355 in order to follow the scheduled path 351 (see FIG. 8A) for the host vehicle M.

The cut-in determination unit 325 is a functional member corresponding to the recognition unit 140 of the vehicle control apparatus 100 illustrated in FIG. 2.

### <Interference Determination Unit 327>

As illustrated in FIG. 6, the interference determination unit 327 has a function of determining, based on the scheduled path 351 for the host vehicle M estimated by the estimation unit 321 and the scheduled path 353 for the traffic participants (candidate vehicle 8) predicted by the prediction unit 323, whether these two scheduled paths 351 and 353 will interfere with each other in a predetermined time period, when the result of the cut-in determination by the cut-in determination unit 325 indicates that the host vehicle M is in a traffic situation in which the host vehicle M needs to cut into the congested traffic line 355 (see FIG. 8A).

Here, the predetermined time period is defined as a condition for the occurrence of interference between the two scheduled paths 351 and 353 for the following reason. Specifically, even if the two scheduled paths 351 and 353 interfere (cross) with each other, a substantial interference (including abnormal approach and collision) will not occur as long as the respective passage time periods do not conflict with each other. Thus, a predetermined time period in which the two scheduled paths 351 and 353 are assumed to interfere with each other is defined and, if the two scheduled paths 351 and 353 interferes with each other in this time period, it is assumed that the two scheduled paths 351 and 353 will substantially interfere with each other.

As the length of the predetermined time period, an appropriate time length may be set as appropriate by taking the above purpose into account.

The interference determination unit 327 determines whether following the scheduled path 351 for the host vehicle M in a situation where the host vehicle M needs to cut into the congested traffic line 355 will result in interference with the scheduled path 353 for the traffic participants (candidate vehicle 8).

The interference determination unit 327 is a functional member corresponding to the recognition unit 140 of the vehicle control apparatus 100 illustrated in FIG. 2.

### <Extraction Unit 329>

As illustrated in FIG. 6, the extraction unit 329 has a function of, when the result of the determination by the interference determination unit 327 indicates that the two scheduled paths 351 and 353 will interfere with each other in the predetermined time period, extracting a specific traffic participant to be involved in the interference (candidate vehicle 8) among the traffic participants.

Note that the extraction unit 329 may employ a configuration which, when a plurality of specific traffic participants are present, further extracts, on the basis of the behavior of specific traffic participants present around the host vehicle M based on the outside information, a highest-degree specific traffic participant whose degree of interference with the host vehicle M is assumed to be the highest among the extracted specific traffic participants. Here, the degree of interference with the host vehicle M is equivalent to the degree of interference (including approach and collision) of the highest-degree specific traffic participant with the host vehicle M.

The extraction unit 329 is a functional member corresponding to the recognition unit 140 of the vehicle control apparatus 100 illustrated in FIG. 2.

### <Information Presentation Unit 331>

As illustrated in FIG. 6, the information presentation unit 331 is configured of a right eye equivalent unit 91A (see FIGS. 5A and 5C), a left eye equivalent unit 91B (see FIG. 5A), and a front display unit 93 (see FIG. 5A).

The (pair of) right and left eye equivalent units 91A and 91B are functional members corresponding to the right and left front light units 91A and 91B (see FIG. 5A), respectively. In the autonomous driving vehicle information presentation apparatus 300 according to the embodiment of the present invention, the (pair of) right and left eye equivalent units 91A and 91B, which are equivalent to the eyes of the host vehicle M on the assumption that the host vehicle M is personified in a front view, are used to direct a sight line SL to a specific traffic participant (see the candidate vehicle 8 in FIG. 8A) extracted by the extraction unit 329 to communicate with this specific traffic participant.

Also, the front display unit 93 has a function of displaying information addressed to a traffic participant present ahead of the host vehicle M in the direction of advance (including a specific traffic participant). In the autonomous driving vehicle information presentation apparatus 300 according to the embodiment of the present invention, the front display unit 93 is used to display a message (information for avoiding interference, i.e., for requesting to cutting into the congested traffic line 355) addressed to a specific traffic participant (candidate vehicle 8) extracted by the extraction unit 329 to communicate with this specific traffic participant.

The pair of eye equivalent units 91A and 91B and the front display unit 93 correspond to the “exterior display apparatus 83” in the present invention.

The information presentation unit 331 has a function of presenting information for avoiding interference between the host vehicle M and the specific traffic participant (candidate vehicle 8) by using the pair of eye equivalent units 91A and 91B and the front display unit 93. The information presentation unit 331 is a functional member corresponding to the HMI control unit 170 of the vehicle control apparatus 100 illustrated in FIG. 2. The function of the information presentation unit 331 will be described later in detail.

### [Operation of Autonomous Driving Vehicle Information Presentation Apparatus 300]

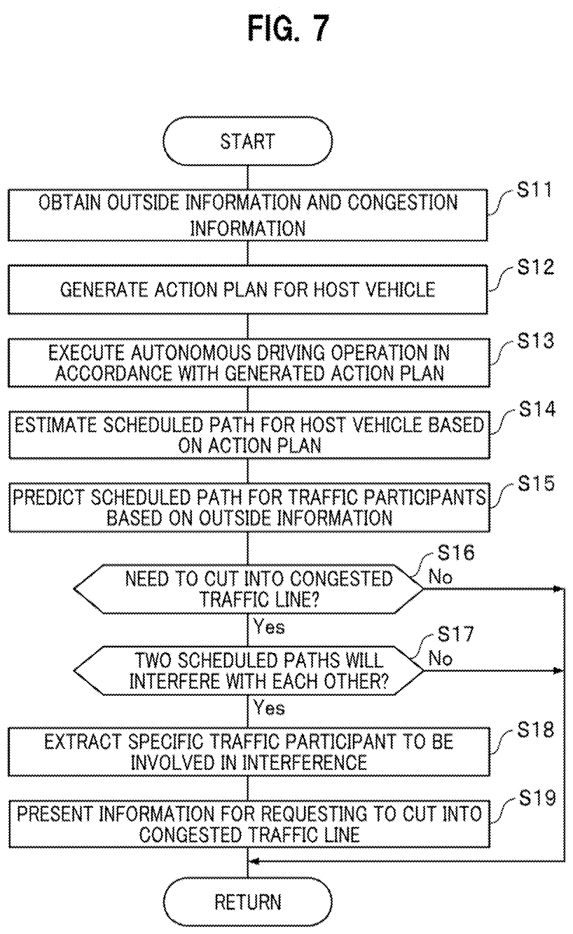

Next, the operation of the autonomous driving vehicle information presentation apparatus 300 according to an embodiment of the present invention will be described with reference to FIG. 7.

FIG. 7 is a flowchart to be used to describe the operation of the autonomous driving vehicle information presentation apparatus 300.

It is assumed that the autonomous driving vehicle (host vehicle) M equipped with the autonomous driving vehicle information presentation apparatus 300 is traveling in a preset level of autonomous driving mode.

In step S11 illustrated in FIG. 7, the outside information obtaining unit 311 obtains outside information on the state of distribution of targets present in an area around the host vehicle M including areas ahead of the host vehicle M in the direction of advance which are detected by the external sensor 10. Also, the congestion information obtaining unit 313 obtains congestion information on congestion ahead of the host vehicle M in the direction of advance.

In step S12, the action plan generation unit 144 generates an action plan for the host vehicle M based on the outside information, the congestion information, and the traffic signal information obtained in step S11.

In step S13, the travel control unit 160 (see FIG. 2) executes an autonomous driving operation in accordance with the action plan for the host vehicle M generated by the action plan generation unit 144.

In step S14, the estimation unit 321 estimates the scheduled path 351 (see FIG. 8A) for the host vehicle M based on the action plan for the host vehicle M generated in step S12.

In step S15, the prediction unit 323 predicts the scheduled path 353 (see FIG. 8A) for traffic participants (candidate vehicle 8) present around the host vehicle M based on the outside information obtained by the outside information obtaining unit 311.

In step S16, the cut-in determination unit 325 determines whether the host vehicle M is in a traffic situation in which the host vehicle M needs to cut into the congested traffic line 355 (see FIG. 8A), based on the congestion information obtained by the congestion information obtaining unit 313, the outside information obtained by the outside information obtaining unit 311, and the scheduled path 351 for the host vehicle M estimated by the estimation unit 321.

If the result of the determination in step S16 indicates that the host vehicle M does not need to cut into the congested traffic line 355, the autonomous driving vehicle information presentation apparatus 300 causes the process flow to return to step S11 and performs the processes from step S11.

If, on the other hand, the result of the determination in step S16 indicates that the host vehicle M needs to cut into the congested traffic line 355, the autonomous driving vehicle information presentation apparatus 300 causes the process flow to advance to the next step S17.

If the result of the cut-in determination by the cut-in determination unit 325 indicates that (the host vehicle M is in a traffic situation in which) the host vehicle M needs to cut into the congested traffic line 355, then in step S17, the interference determination unit 327 determines, based on the scheduled path 351 for the host vehicle M estimated by the estimation unit 321 and the scheduled path 353 for the traffic participants (candidate vehicle 8) predicted by the prediction unit 323, whether these two scheduled paths 351 and 353 will interfere with each other in a predetermined time period.

If the result of the determination in step S17 indicates that the two scheduled paths 351 and 353 will not interfere with each other in the predetermined time period, the autonomous driving vehicle information presentation apparatus 300 causes the process flow to return to step S11 and performs the processes from step S11.

If, on the other hand, the result of the determination in step S17 indicates that the two scheduled paths 351 and 353 will interfere with each other in the predetermined time period, the autonomous driving vehicle information presentation apparatus 300 causes the process flow to advance to the next step S18.

If the result of the determination by the interference determination unit 327 indicates that the two scheduled paths 351 and 353 will interfere with each other in the predetermined time period, then in step S18, the extraction unit 329 extracts the specific traffic participant to be involved in the interference (candidate vehicle 8) among the traffic participants.

In step S19, the information presentation unit 331 presents information for avoiding interference between the host vehicle M and the specific traffic participant (the candidate vehicle 8 in FIG. 8A) by using the pair of eye equivalent units 91A and 91B and the front display unit 93.

Specifically, the information presentation unit 331 presents the information for avoiding interference between the host vehicle M and the specific traffic participant (the candidate vehicle 8 in FIG. 8A) (a request to cut in) to the specific traffic participant as the presentation target by directing a sight line SL (see FIG. 8A, for example) to the specific traffic participant with the pair of eye equivalent units 91A and 91B and displaying a message addressed to the specific traffic participant with the front display unit 93. In this way, the host vehicle M communicates with the specific traffic participant.

### [Operation of Autonomous Driving Vehicle Information Presentation Apparatus 300 According to Embodiment of Present Invention]

Next, the operation of the autonomous driving vehicle information presentation apparatus 300 according to an embodiment of the present invention will be described with reference to FIGS. 8A, 8B, 9, and 10A to 100.

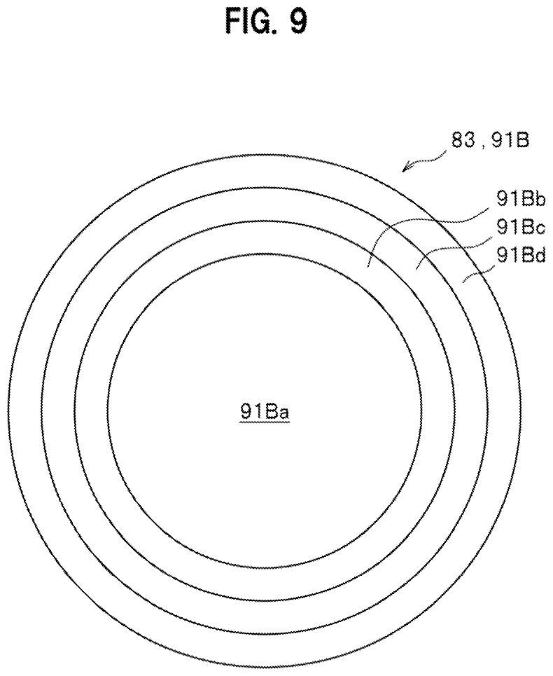

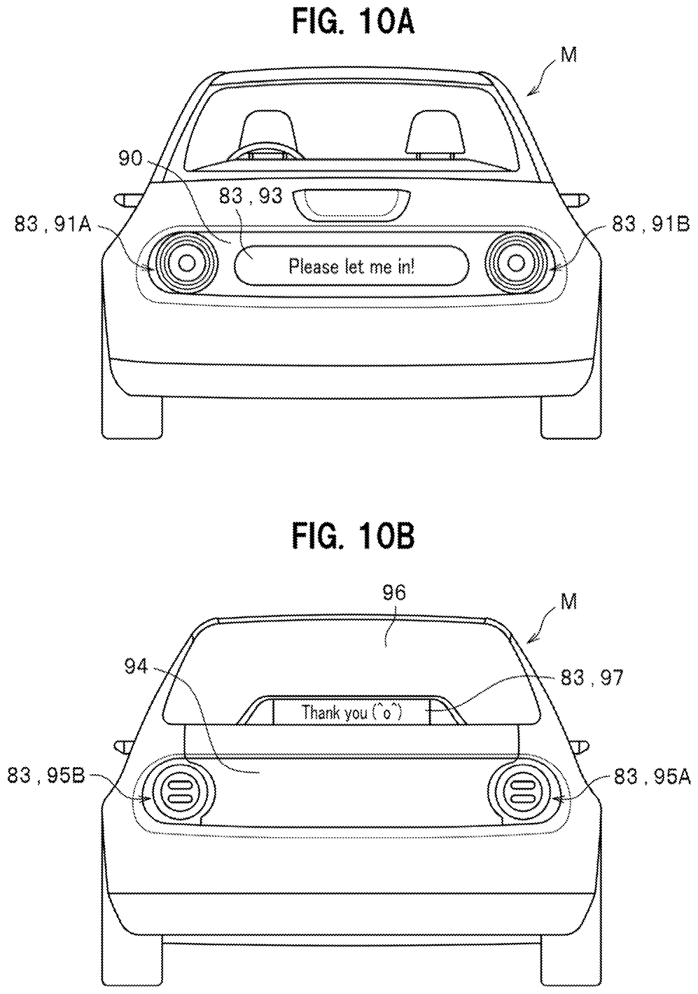

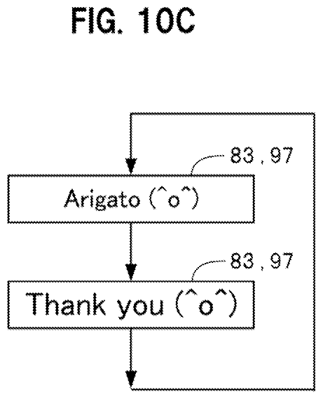

FIGS. 8A and 8B are diagrams sequentially illustrating a traveling scene of the autonomous driving vehicle M requesting to cut into the congested traffic line 355. FIG. 9 is a front view illustrating a schematic configuration of the left front light unit 91B included in the autonomous driving vehicle M. FIG. 10A is a diagram illustrating an information presenting state of the front display unit 93 provided at a front portion of the autonomous driving vehicle M. FIG. 10B is a diagram illustrating an information presenting state of the rear display unit 97 provided at a rear portion of the autonomous driving vehicle M. FIG. 10C is a diagram illustrating a modification of the information presenting state of the autonomous driving vehicle information presentation apparatus 300.

FIGS. 8A and 8B illustrate a traveling scene of the autonomous driving vehicle M encountering a traffic situation in which a congested traffic line 355 has been formed across a T-shaped intersection TJ with no traffic light installed due to traffic congestion. A crosswalk 3, a center line 4, and a stop line 5 are drawn at predetermined positions on each of roads 2 surrounding the T-shaped intersection TJ.

The congested traffic line 355 illustrated in FIG. 8A is formed of four vehicles in total including a leading vehicle 7b as the first vehicle in the direction of advance, followed by a leading vehicle 7a, a candidate vehicle 8, and a trailing vehicle 9a in this order. In the example illustrated in FIG. 8A, there is an employ space that is as large as the T-shaped intersection TJ between the leading vehicle 7a and the candidate vehicle 8.

The left front light unit 91B illustrated in FIG. 9 is configured such that a turn signal 91Bb, a light display part 91Bc, and a position lamp 91Bd each formed in an annular shape are arranged concentrically in this order toward the radially outer side and centered around a headlamp 91Ba formed in a circular shape in a front view, like the right front light unit 91A.

In the traveling scene illustrated in FIG. 8A, the autonomous driving vehicle M having encountered the traffic situation in which the congested traffic line 355 has been formed due to traffic congestion, and requesting to cut into the congested traffic line 355 is presenting information for avoiding interference (a request to cut in) to a specific traffic participant (candidate vehicle 8) that is present before the T-shaped intersection TJ and to be involved in interference with the autonomous driving vehicle M, when the autonomous driving vehicle M is about to enter the T-shaped intersection TJ.

Specifically, in the autonomous driving vehicle information presentation apparatus 300 mounted in the autonomous driving vehicle M, the information presentation unit 331 directs the sight line L to the specific traffic participant (candidate vehicle 8) by using the pair of eye equivalent units 91A and 91B and displays a message addressed to the specific traffic participant, e.g., “Please let me in! Thank you (̂ô)”, by using the front display unit 93, as illustrated in FIG. 8A. This message corresponds to information for avoiding interference of the host vehicle M, i.e., for requesting to cut into the congested traffic line 355.

In the traveling scene illustrated in FIG. 8B, the autonomous driving vehicle M has completed cutting into the empty space present between the leading vehicle 7a and the candidate vehicle 8 in the congested traffic line 355 illustrated in FIG. 8A. At this point, in the autonomous driving vehicle information presentation apparatus 300 mounted in the autonomous driving vehicle M, the information presentation unit 331 displays a message addressed to the specific traffic participant (the candidate vehicle 8 having accepted the request to cut in), e.g., “Thank you for letting me in (̂ô)” (see FIG. 10B), by using the rear display unit 97, as illustrated in FIG. 8B. This message is information indicating gratitude for accepting the request to cut into the congested traffic line 355.

Note that a configuration may be employed which presents the messages addressed to the specific traffic participant (candidate vehicle 8) with the front display unit 93 and the rear display unit 97 by using one of a plurality of languages including the first language (English) (English and Japanese in the example illustrated in FIG. 10C) while switching between the languages in turn at predetermined time intervals.

With such a configuration, even if the occupant in the specific traffic participant (candidate vehicle 8) is a foreigner, the host vehicle M can communicate with the specific traffic participant (candidate vehicle 8). This makes it possible to create a smooth traffic environment even when unpredicted traffic congestion occurs.

### [Operation and Advantageous Effects of Autonomous Driving Vehicle Information Presentation Apparatuses 300 According to Embodiments of Present Invention]

Next, operation and advantageous effects of the autonomous driving vehicle information presentation apparatuses 300 according to the embodiments of the present invention will be described.

An autonomous driving vehicle information presentation apparatus 300 based on an aspect (1) is based on an autonomous driving vehicle information presentation apparatus 300 that is used in an autonomous driving vehicle M which obtains outside information on an outside including traffic participants present around a host vehicle M (see reference signs 7a, 7b, 8, and 9a in FIG. 8A), generates an action plan for the host vehicle M based on the obtained outside information, and autonomously controls at least one of speed and steering of the host vehicle M in accordance with the generated action plan, and that presents information to the traffic participants.

The autonomous driving vehicle information presentation apparatus 300 based on the aspect (1) includes: an estimation unit 321 that estimates a scheduled path 351 for the host vehicle M based on the action plan; a prediction unit 323 that predicts a scheduled path 353 for the traffic participants based on the outside information; an interference determination unit 327 that determines, based on the scheduled path 351 for the host vehicle M estimated by the estimation unit 321 and the scheduled path 353 for the traffic participants predicted by the prediction unit 323, whether these two scheduled paths 351 and 353 will interfere with each other in a predetermined time period; an extraction unit 329 that, when a result of the determination by the interference determination unit 327 indicates that the two scheduled paths 351 and 353 will interfere with each other in the predetermined time period, extracts a specific traffic participant 8 to be involved in the interference among the traffic participants; and an information presentation unit 331 that presents information addressed to the traffic participants by using an exterior display apparatus 83, 93 provided at a front portion of the host vehicle M.

The information presentation unit 331 employs a configuration that presents information for avoiding the interference to the specific traffic participant (candidate vehicle 8) extracted by the extraction unit 329 as a presentation target.

In the autonomous driving vehicle information presentation apparatus 300 based on the aspect (1), the estimation unit 321 estimates the scheduled path 351 for the host vehicle M based on the action plan for the host vehicle M. The prediction unit 323 predicts the scheduled path 353 for the traffic participants based on the outside information. The interference determination unit 327 determines, based on the scheduled path 351 for the host vehicle M estimated by the estimation unit 321 and the scheduled path 353 for the traffic participants predicted by the prediction unit 323, whether these two scheduled paths 351 and 353 will interfere with each other in a predetermined time period. When the result of the determination by the interference determination unit 327 indicates that the two scheduled paths 351 and 353 will interfere with each other in the predetermined time period, the extraction unit 329 extracts the specific traffic participant (candidate vehicle 8) to be involved in the interference among the traffic participants. The information presentation unit 331 presents information addressed to the traffic participants by using the exterior display apparatus 83 (a pair of eye equivalent units 91A and 91B and a front display unit 93) provided at the front portion of the host vehicle M.

In particular, the information presentation unit 331 presents information for avoiding the interference to the specific traffic participant (candidate vehicle 8) extracted by the extraction unit 329 as the presentation target.

According to the autonomous driving vehicle information presentation apparatus 300 based on the aspect (1), when the autonomous driving vehicle M encounters a traffic situation in which, for example, a congested traffic line 355 has been formed across a T-shaped intersection TJ with no traffic light installed due to traffic congestion, the information presentation unit 331 presents information for avoiding interference to a specific traffic participant with which the probability of the two scheduled paths 351 and 353 interfering with each other in the predetermined time period is high.

Thus, by attracting the attention of the specific traffic participant that is likely to interfere with the host vehicle M, the host vehicle M can communicate with the traffic participant present around the host vehicle M (specific traffic participant). This enables the autonomous driving vehicle M to create a smooth traffic environment between the host vehicle M and the traffic participant present around it (specific traffic participant).

An autonomous driving vehicle information presentation apparatus 300 based on an aspect (2) is the autonomous driving vehicle information presentation apparatus 300 based on the aspect (1) further including a congestion information obtaining unit 313 that obtains congestion information on congestion ahead of the host vehicle M in a direction of advance; and a cut-in determination unit 325 that determines whether the host vehicle M is in a traffic situation in which the host vehicle M needs to cut into a congested traffic line 355, based on the congestion information obtained by the congestion information obtaining unit 313, the outside information, and the scheduled path 351 for the host vehicle M.

The interference determination unit 327 employs a configuration that determines whether the two scheduled paths 351 and 353 will interfere with each other in the predetermined time period when a result of the determination by the cut-in determination unit 325 indicates that the host vehicle M is in the traffic situation in which the host vehicle M needs to cut into the congested traffic line 355.

In the autonomous driving vehicle information presentation apparatus 300 based on the aspect (2), the congestion information obtaining unit 313 obtains the congestion information on congestion ahead of the host vehicle M in the direction of advance. The cut-in determination unit 325 determines whether the host vehicle M is in a traffic situation in which the host vehicle M needs to cut into the congested traffic line 355, based on the congestion information obtained by the congestion information obtaining unit 313, the outside information, and the scheduled path 351 for the host vehicle M.

The interference determination unit 327 determines whether the two scheduled paths 351 and 353 will interfere with each other in the predetermined time period when the result of the determination by the cut-in determination unit 325 indicates that the host vehicle M is in the traffic situation in which the host vehicle M needs to cut into the congested traffic line 355.

According to the autonomous driving vehicle information presentation apparatus 300 based on the aspect (2), the interference determination unit 327 determines whether the two scheduled paths 351 and 353 will interfere with each other in the predetermined time period when the result of the determination by the cut-in determination unit 325 indicates that the host vehicle M is in the traffic situation in which the host vehicle M needs to cut into the congested traffic line 355. Thus, in addition to the above-described advantageous effect achieved by the autonomous driving vehicle information presentation apparatus 300 based on the aspect (1), it is possible to minimize the frequency of making a determination with the interference determination unit 327.

An autonomous driving vehicle information presentation apparatus 300 based on an aspect (3) is the autonomous driving vehicle information presentation apparatus 300 based on the aspect (1) in which the exterior display apparatus 83 includes a pair of eye equivalent units (right and left front light units) 91A and 91B provided at portions of the host vehicle M where headlights thereof are installed, and equivalent to eyes of the host vehicle M on an assumption that the host vehicle M is personified in a front view, and a front display unit 93 provided between the pair of eye equivalent units 91A and 91B.

The information presentation unit 331 employs a configuration that presents information for cutting into the congested traffic line 355 to the specific traffic participant (candidate vehicle 8) as the presentation target by directing a sight line SL to the specific traffic participant with the pair of eye equivalent units 91A and 91B and displaying a message addressed to the specific traffic participant with the front display unit 93.

In the autonomous driving vehicle information presentation apparatus 300 based on the aspect (3), the information presentation unit 331 presents the information for requesting to cut into the congested traffic line 355 to the specific traffic participant as the presentation target by directing the sight line SL to the specific traffic participant with the pair of eye equivalent units 91A and 91B and displaying a message addressed to the specific traffic participant with the front display unit 93.

According to the autonomous driving vehicle information presentation apparatus 300 based on the aspect (3), the information presentation unit 331 presents the information for requesting to cut into the congested traffic line 355 to the specific traffic participant as the presentation target by directing the sight line SL to the specific traffic participant with the pair of eye equivalent units 91A and 91B and displaying a message addressed to the specific traffic participant with the front display unit 93. In this way, it is possible to properly and accurately convey a request to cut into the congested traffic line 355 addressed to a specific traffic participant with a high probability of interfering with the host vehicle M.

Making use of the directing of the sight line SL (eye contact) with the pair of eye equivalent units 91A and 91B and the displaying of a message with the front display unit 93 as described above makes it possible to actively communicate with the specific traffic participant. This enables the autonomous driving vehicle M to create a smooth traffic environment between the host vehicle M and the traffic participant present around it (specific traffic participant).

Also, an autonomous driving vehicle information presentation apparatus 300 based on an aspect (4) is the autonomous driving vehicle information presentation apparatus 300 based on the aspect (3) and may employ a configuration in which the information presentation unit 331 displays the message addressed to the specific traffic participant with both or one of a character and a design by using the front display unit 93.

In the autonomous driving vehicle information presentation apparatus 300 based on the aspect (4), the information presentation unit 331 displays the message addressed to the specific traffic participant with both or one of a character and a design by using the front display unit 93.

According to the autonomous driving vehicle information presentation apparatus 300 based on the aspect (4), the information presentation unit 331 displays the message addressed to the specific traffic participant with both or one of a character and a design by using the front display unit 93. Thus, in addition to the above-described advantageous effect achieved by the autonomous driving vehicle information presentation apparatus 300 based on the aspect (3), it is possible to further enhance the appealing effect of the request to cut into the congested traffic line 355 addressed to the specific traffic participant 8 and thus make intimate communication with the specific traffic participant 8.

An autonomous driving vehicle information presentation apparatus 300 based on an aspect (5) is the autonomous driving vehicle information presentation apparatus 300 based on the aspect (3) employing a configuration in which the information presentation unit 331 presents the information addressed to the specific traffic participant 8 and the congestion information by using one of a plurality of languages including a first language while switching between the languages in turn at predetermined time intervals.

In the autonomous driving vehicle information presentation apparatus 300 based on the aspect (5), the information presentation unit 331 presents the information addressed to the trailing vehicle 7a and the congestion information by using one of the plurality of languages including the first language while switching between the languages in turn at the predetermined time intervals.

The autonomous driving vehicle information presentation apparatus 300 based on the aspect (5) presents the congestion information and the like addressed to the trailing vehicle 7a by using one of the plurality of languages including the first language while switching between the languages in turn at the predetermined time intervals. In this way, even if the occupant in the trailing vehicle 7a is a foreigner and unpredicted traffic congestion occurs, the host vehicle M can communicate with the traffic participant present around the host vehicle M and as a result create a smooth traffic environment.

### OTHER EMBODIMENTS

The plurality of embodiments described above represent examples of embodying the present invention. Therefore, the technical scope of the present invention shall not be interpreted in a limited manner by these embodiments. This is because the present invention can he implemented in various ways without departing from its gist or its main characteristic features.

Lastly, the present invention can be implemented by providing a program that implements one or more of the functions according to the above-described embodiments to a system or an apparatus via a network or from a storage medium, and causing one or more processors in a computer of the system or the apparatus to read out and execute the program. Alternatively, the present invention may be implemented with a hardware circuit (e.g., ASIC) that implements one or more of the functions. Information including the program that implements the functions can be held in a recording apparatus such as a memory or a HDD or a recording medium such as a memory card or an optical disk.

What is claimed is:

1. An autonomous driving vehicle information presentation apparatus that is used in an autonomous driving vehicle which obtains outside information on an outside including traffic participants present around a host vehicle, generates an action plan for the host vehicle based on the obtained outside information, and autonomously controls at least one of speed and steering of the host vehicle in accordance with the generated action plan, and that presents information to the traffic participants, the autonomous driving vehicle information presentation apparatus comprising:
an estimation unit that estimates a scheduled path for the host vehicle based on the action plan;
a prediction unit that predicts a scheduled path for the traffic participants based on the outside information;
an interference determination unit that determines, based on the scheduled path for the host vehicle estimated by the estimation unit and the scheduled path for the traffic participants predicted by the prediction unit, whether these two scheduled paths will interfere with each other in a predetermined time period;
an extraction unit that, when a result of the determination by the interference determination unit indicates that the two scheduled paths will interfere with each other in the predetermined time period, extracts a specific traffic participant to be involved in the interference among the traffic participants; and
an information presentation unit that presents information addressed to the traffic participants by using an exterior display apparatus provided at a front portion of the host vehicle,
wherein the information presentation unit presents information for avoiding the interference to the specific traffic participant extracted by the extraction unit as a presentation target.

2. The autonomous driving vehicle information presentation apparatus according to claim 1, further comprising
a congestion information obtaining unit that obtains congestion information on congestion ahead of the host vehicle in a direction of advance; and
a cut-in determination unit that determines whether the host vehicle is in a traffic situation in which the host vehicle needs to cut into a congested traffic line, based on the congestion information obtained by the congestion information obtaining unit, the outside information, and the scheduled path for the host vehicle,
wherein the interference determination unit determines whether the two scheduled paths will interfere with each other in the predetermined time period when a result of the determination by the cut-in determination unit indicates that the host vehicle is in the traffic situation in which the host vehicle needs to cut into the congested traffic line.

3. The autonomous driving vehicle information presentation apparatus according to claim 2, wherein
the exterior display apparatus includes
a pair of eye equivalent units provided at portions of the host vehicle where headlights thereof are installed, and equivalent to eyes of the host vehicle on an assumption that the host vehicle is personified in a front view, and
a front display unit provided between the pair of eye equivalent units, and
the information presentation unit presents information for requesting to cut into the congested traffic line to the specific traffic participant as the presentation target by directing a sight line to the specific traffic participant with the pair of eye equivalent units and displaying a message addressed to the specific traffic participant with the front display unit.

4. The autonomous driving vehicle information presentation apparatus according to claim 3, wherein the information presentation unit displays the message addressed to the specific traffic participant with both or one of a character and a design by using the front display unit.

5. The autonomous driving vehicle information presentation apparatus according to claim 3, wherein the information presentation unit presents the information addressed to the specific traffic participant by using one of a plurality of languages including a first language while switching between the languages in turn at predetermined time intervals.
